(19) United States
(12) Patent Application Publication
(10) Pub. No.: US 2002/0052292 A1
(43) Pub. Date: May 2, 2002

(54) Process for producing a catalytic converter and catalytic converter made by said process

(76) Inventors: Ellen Dahlhoff, Blaustein (DE); Wilm Eickelberg, Hagen (DE); Anett Funke, Neu-Ulm (DE)

Correspondence Address: CROWELL & MORING, L.L.P., 1200 G Street, N.W., Suite 700, Washington, DC, 20005, US

(21) Appl. No.: 09/944,148

(22) Filed: Sep. 4, 2001

(30) Foreign Application Priority Data
Sep. 4, 2000 (DE) 100 43 865.2

(51) Int. Cl. B01J 23/00

(52) U.S. Cl. 502/325; 502/334

(57) ABSTRACT

A process for producing a catalytic converter utilizes deposition of a catalytically active material electrochemically deposited on a substrate as aresult of the substrate being immersed in an electrolyte, which contains the catalytically active material, and an electric voltage being applied between the substrate and a counterelectrode. The platinum is deposited on a metallic substrate from a platinum-containing sulphuric acid solution, or in which process a Pt/Ru mixture is deposited on a metallic substrate from a sulphuric acid solution containing platinum and ruthenium as catalytically active material, which a Pt:Ru ratio of from 1:10 to 1:20.

### BACKGROUND AND SUMMARY OF THE INVENTION

This application claims the priority of German Patent Document 100 43 865.2, filed Sep. 4, 2000, the disclosure(s) of which is (are) expressly incorporated by reference herein.

The invention relates to a process for producing a catalytic converter and to a catalytic converter made by the process. Prefered embodiments of the invention relate to a process for producing a catalytic converter, in which catalytically active material is electrochemically deposited on. a substrate as a result of the substrate being immersed in an electrolyte, which contains the catalytically active material, and an electric voltage being applied between the substrate, and a counterelectrode.

The disclosure of Japanese Patent Publication JP-A-08 134 682 has described an electroplating process for coating a metallic substrate with a smooth layer of precious metal, in which an iron-containing substrate is provided with a covering of platinum. German Patent Document DE 197 32 170 C2 has disclosed a process for covering a ceramic SiC substrate with a platinum covering in a locally selective manner, the surface of this covering matching the rough ceramic surface, as a result of a direct voltage being applied between the substrate and a counterelectrode. The coated substrate is then treated at an elevated temperature of over 400° C.

An object of the invention is to provide a process for coating a metallic substrate which allows the deposition of a catalytically active material with a large surface area and good adhesion to a steel substrate.

This object is achieved according to certain preferred embodiments of the invention by providing a process for producing a catalytic converter, in which catalytically active material is electrochemically deposited on a substrate as a result of the substrate being immersed in an electrolyte, which contains the catalytically active material, and an electric voltage being applied between the substrate, and a counterelectrode, said process comprising one of: (i) depositing platinum on a metallic substrate from a platinum-containing sulphuric acid solution; and (ii) depositing a platinum/ruthenium mixture on a metallic substrate from a sulphuric acid solution containing platinum and ruthenium as catalytically active material, with a Pt:Ru ratio of 1:10 to 1:20.

According to the invention, a layer of catalytically active metallic material is deposited on a metal substrate by means of electrochemical deposition, the substrate being immersed in an electrolyte which contains the catalytically active metallic material, preferably in the form of a precursor, and an electric voltage being applied between the substrate and a counterelectrode, and the catalytically active material being deposited on the substrate as a porous or non-cohesive layer.

It is particularly advantageous for the substrate to be provided, on its surf ace which is to be coated, with a predetermined surface roughness prior to the deposition, the surface roughness preferably lying in the range from 0.3 μm to 10 μm. A further preferred range for the surface roughness is between 0.3 μm and 3 μm. The surface roughness is expediently. produced by thermal and/or mechanical and/or chemical treatment.

The catalytically active material is preferably formed from metal clusters with a diameter of between 2 nm and 1 μm, preferably between 2 nm and 300 nm.

The particular advantage of the process is that the deposition of catalytically active layers takes place with a very large surface area and a relatively low catalytically active material content. The layers present good adhesion to the steel substrate and remain stable even when used for prolonged periods at high temperatures.

Preferred catalytically active materials contain precious metals. A suitable catalytically active material is platinum. A further expedient material is platinum/ruthenium. A preferred counterelectrode is formed by platinum-coated titanium sheet. A further preferred counterelectrode consists of platinum-coated nickel.

Further advantages and configurations of the invention will emerge from the further claims and from the description. The invention is described in more detail below with reference to the drawings.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an outline view of a construction which is used to carry out the process according to the invention;

FIG. 2 diagrammatically depicts a section through a coated surface;

FIG. 3 shows the change in the electrical conductivity of the RuCl₃ solution caused by the aging phenomenon; and

FIG. 4 shows a scanning electron microscope image of a Pt/Ru layer formed using a preferred embodiment of the invention.

### DETAILED DESCRIPTION OF THE DRAWINGS

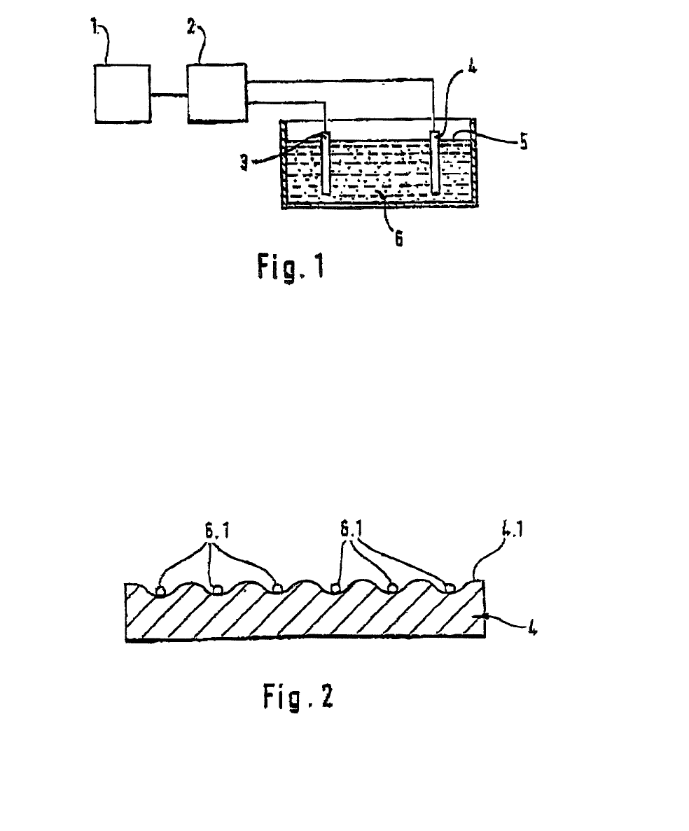

FIG. 1 shows an arrangement which is used to carry out the process according to the invention. A function generator 1 generates a voltage which, as appropriate, is amplified in an amplifier 2 and is applied between an anode 3 and a substrate 4 which is to be coated, in a deposition bath 5. In the process, it is preferably possible to apply a constant direct voltage V_{dc}, but it is also possible to apply a modulated direct voltage Vₘ, in which an alternating voltage V_{ac} is superimposed on a direct voltage V_{dc}. The alternating voltage is expediently sinusoidal, but may also adopt other forms, for example sawtooth or square-wave form. The alternating voltage V_{ac} preferably has an amplitude which is lower than the direct voltage V_{dc}.

The catalytically active material 6 is deposited on the substrate 4 in the form of clusters. The clusters may be of different shapes which can be advantageously predetermined by the deposition parameters. The substrate 4 coated with catalytically active material 6 then forms the catalytic converter.

The direct voltage V_{dc}, is preferably at least as great as the deposition potential of the catalytically active material 6 on the substrate 4, and particularly preferably is at most 50% greater than this potential. In the case of a mixed catalyst, in which the individual components have different deposition potentials, this preferably relates to the material with the highest deposition potential of the components used. The precise value of the direct voltage V_{dc}, is dependent on the constituents and process conditions used and may, for example, adopt different values for differently pretreated substrates, although these values do not generally differ greatly from one another. When depositing mixed systems as the catalytically active material, it is also possible for the preferred direct voltage V_{dc}, to lie below this deposition potential. A favorable value for a given system can be determined by means of cyclic voltammetry in a manner which is known per se.

A particularly appropriate substrate for use is stainless steel, preferably Cr-Ni steel 1.4541 or Cr-Ni steel 1.4571 or Cr-Al steel 1.4767. Aluminum-containing steel is particularly expedient for Pt/Ru mixed catalysts.

It is expedient for the substrate to be sand-blasted or roughened in some other way, for example chemically, and to undergo alkaline degreasing prior to the coating. This improves the adhesion of the catalytically active material 6 to the substrate 4.

The current between substrate 4, which serves as a. cathode during the deposition, and anode 3 is recorded and, in accordance with Faraday's law, can be used as a measure for determination of the deposited quantity of the catalytically active material 6 which is contained in the deposition bath, current contributions which flow in order to build up and break down the electrolytic double layer on account of the modulation expediently being eliminated, since they do not derive from the reduction or oxidation of cations or anions.

To produce the catalytic converter, it is preferable to deposit a precious metal, such as Pt, or mixtures of precious metals with further catalytically active materials, preferably Pt/Ru. An expedient, inexpensive anode is platinum-coated titanium, instead of a conventional sacrificial anode made from solid platinum, which can be used particularly advantageously if platinum is to be deposited as a component of the catalytically active material. However, other precious metals and also other metals can also be deposited in this inventive way. Preferably, elements from subgroup VIIIB are also deposited, particularly preferably ruthenium, osmium, iridium.

The voltage applied may be adjusted in terms of the voltage offset V_{dc}., so as to optimize the deposition parameters for the particular system. When using modulated direct voltage, the deposition parameters may also be set accordingly in terms of the frequency and/or the amplitude of the modulation voltage.

The values can influence both the size of the clusters which are deposited on the metallic cathode and their morphology. For different intended purposes, the optimum cluster size can in each case be established by suitably selecting the deposition parameters and the coating duration.

Overall, the clusters on the substrate 4 provide a large active surface area for catalytic reactions. It is particularly advantageous for the surface of the substrate 4 which is to be coated to be roughened prior to the coating, for example by pickling or sandblasting. Other methods of increasing the surface roughness are also possible. This is illustrated in FIG. 2 on the basis of a diagrammatic side view of a coated surface. A substrate 4 has a roughened surface 4.1, on which spherical metal clusters 6.1 are arranged in recesses. The metal clusters 6.1 may also be deposited on the peaks or flanks of the roughened areas.

The increased surface roughness has the advantage that deposited clusters 6.1 adhere better to the substrate surface, and undesirable aggregation of the clusters 6.1 during the deposition or also at elevated temperatures when the catalytic converter is operating is supressed. A catalytically active layer comprising individual clusters 6.1 is formed, the layer preferably not being continuous, but rather being formed from isolated clusters 6.1.

The surface roughness is preferably between 0.3 μm and 10 μm, particularly preferably between 0.3 μm and 3 μm. The finely dispersed clusters 6.1 result in a large active surface area being formed. A further advantage is that the increased surface roughness itself also contributes to increasing the surface area of the substrate 4 and therefore also the chemically active surface area. At the same time, the clusters 6.1 can be very small, so that overall only a small quantity of the expensive catalytically active material 6 has to be deposited, yet at the same time the catalytic converter is distinguished by a high catalytic activity.

The adhesion of the metallic clusters 6.1 to the substrate surface 4.1 is very good. This makes the catalyst layer more resistant to erosion, so that scarcely any loss of material is observed even in the event of frequent temperature changes and high loads in operation.

Above all, it is advantageous that, on account of the good adhesion, there is no need to apply an additional adhesion promoter layer between the catalytically active layer and the substrate. A particular advantage over conventional catalytic converters of this type consists in the fact that, according to the invention, very good heat transfer from the catalyst layer to the substrate 4 is possible, since metallic clusters 6.1 are joined to a metallic substrate 4. An adhesion promoter layer would significantly impair the heat transfer.

A coated substrate 4 according to the invention is therefore particularly suitable for use as an oxidation catalytic converter for treating exhaust gases in fuel cell systems. A further expedient application is for various heterogeneously catalyzed processes. The catalytic converter according to the invention and the process according to the invention are particularly advantageous for exhaust-gas catalytic converters for vehicles.

A particularly preferred catalytic converter is produced by deposition of ruthenium on stainless steel, preferably comprising aluminum-containing stainless steel sheet 1.4767. substrate has the considerable advantage that it is passivated when used at high temperatures and is therefore protected against corrosion.

As well as the preferred mixed catalysts of platinum/ruthenium, in this way it is also possible to deposit catalysts comprising mixtures of precious metals with catalytically active materials from subgroup VIIIB, such as for example PtRh, PtPd, PtIr, PtOs.

A catalytic converter of this type has a very good activity for methanol and hydrogen and, firstly, a high tolerance to carbon monoxide, and preferably also good conversion of carbon monoxide. A catalytic converter of this type is therefore particularly suitable for use in methanol-operated fuel cell vehicles, particularly preferably in catalytic burners.

For the co-deposition of platinum and ruthenium, it has been found that parameters such as temperature, concentration of the conductive electrolyte, concentration of the platinum in the electrolyte, have scarcely any effect on the deposition system.

The temperature can therefore expediently be kept at room temperature, while the conductive electrolyte is preferably based on sulphuric acid. A concentration of the conductive electrolyte of preferably 0.1 molar sulphuric acid is expedient. A method which does not promote layer growth is preferred for the deposition. Therefore, during the co-deposition of platinum and ruthenium, a pulsed current process promotes layer growth and supresses nucleation, unlike when depositing pure platinum. Therefore, for co-deposition it is preferable to apply an offset voltage, but without a superimposed pulsed voltage.

The use of H₂PtCl₆ and RuCl₃ as electrodeposition salts is advantageous for the production of the mixed catalysts. Tests carried out using other salts, for example RuNC, a ruthenium nitrooctachloro complex, lead to less satisfactory results.

The deposition of the mixed catalysts is principally influenced by two factors, namely the offset voltage and the ruthenium concentration.

A voltage range for the offset voltage of between 1000 mV and 1400 mV is expedient. The lower limit results from empirical values, which have demonstrated that it is impossible for catalysts to be effectively deposited at less than 1000 mV. The upper limit is selected for safety reasons, since at higher voltages of over approximately 1.45 V toxic ruthenium (VIII) oxide RuO₄ is formed.

For the ruthenium concentration, a concentration ratio in which there is more ruthenium than platinum in the electrolyte solution is preferred. A Pt:Ru ratio in the range from 1:10 to 1:20 is preferred. In this way, it is possible to obtain a platinum/ruthenium ratio of 1:1 in the deposited layer, resulting in an optimum catalytically active surface of the catalytic converter.

Therefore, at a preferred platinum content of 0.1 g/l (grams per liter), the ruthenium content is accordingly set at between 1 g/l and 2 g/l. With a platinum content of 0.2 g/l, the result is a preferred ruthenium content of from 2 g/1 to 4 g/l. With 0.05 g/l of platinum, the corresponding favorable ruthenium content is between 0.5 g/l and 1 g/l.

At the beginning of deposition, the electrode system and the electrolyte solution are prepared, the conductive electrolyte used preferably being 0.1-molar sulphuric acid and the conductive salts being produced on the basis of this solution.

It has been found that the Pt and Ru solutions are subject to ageing effects, and should therefore advantageously be made up at least 20 hours, preferably three days (72 hours) prior to the deposition. For example, a freshly prepared aqueous solution of [RuCl₃(H₂O)₃] is not initially dissociated into ionic fractions; only over time, in particular in dilute acidic solution, does hydrolysis take place, so as to form chloride. It is expedient to age the platinum-containing and ruthenium-containing electrolyte 5 under the action of electromagnetic radiation and/or air and/or oxygen. This is favorable for the deposition of Pt and for the co-deposition of Pt/Ru and other mixtures of catalytically active material.

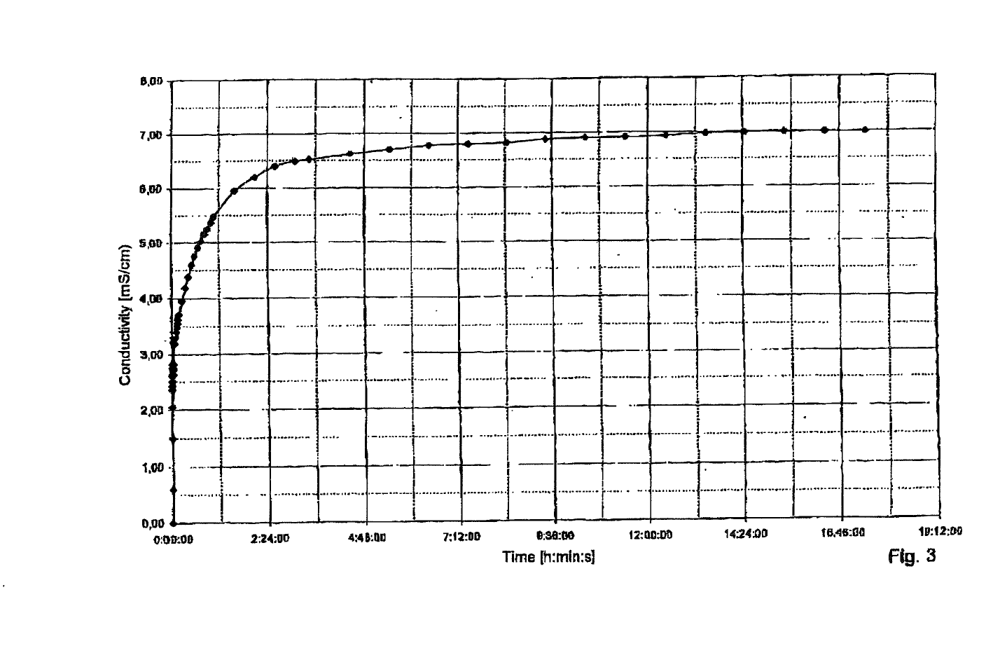

FIG. 3 shows these aging characteristics of an electrolyte solution of RuCl₃. For this purpose, 2 g of RuCl₃-H₂O are dissolved in one liter of water, and the electrical conductivity is measured for 18 hours. The electrical conductivity is initially low. It then rises steeply and approaches a limit value of approximately 7 ms/cm. This corresponds to the observation that it is impossible to deposit ruthenium with a freshly made-up electrolyte. In this case, although RUC1₃ is dissolved, an electroneutral complex which does not react to the application of an external voltage and therefore blocks deposition of ruthenium is formed.

After the counterelectrode and the substrate to be coated has been inserted into the electrolyte, it is expedient to purge the electrolyte solution with an inert gas, preferably argon, in order to expel dissolved foreign gases. To obtain an increased number of ruthenium ions, during the co-deposition of Pt/Ru, it is necessary, compared to a (PtC1₆)⁻² solution, to select a much higher ruthenium concentration than the platinum concentration, preferably of at least 1 g of Ru/1, so that ruthenium is deposited.

It has been found that the deposition of ruthenium during the co-deposition of Pt/Ru is highly passageinhibited and diffusion-inhibited. Therefore, during deposition, the electrolyte solution should as far as possible not be moved or agitated. When voltage is present, first of all Ru (III) is reduced to form Ru (II). The final step of the deposition, namely the reduction of Ru (II) to form metallic ruthenium, is a process which only takes place under conditions which provide an expansive, stationary diffusion layer. Otherwise, all that would be established would be a cyclic reduction of Ru (III) and oxidation of Ru (II).

During the co-deposition of Pt and Ru from a mixed electrolyte, the deposition potential of Pt is approximately 1.3 V, and the deposition potential of Ru is approximately 0.7 V.

It has also been found that catalytic converters with disc-like substrates present a lower degree of conversion than, for example, spherical or cylindrical substrates. Catalytic converters with cylindrical Cr-Al substrates (1.4767) have a conversion rate which is 50% higher than with disc-like substrates.

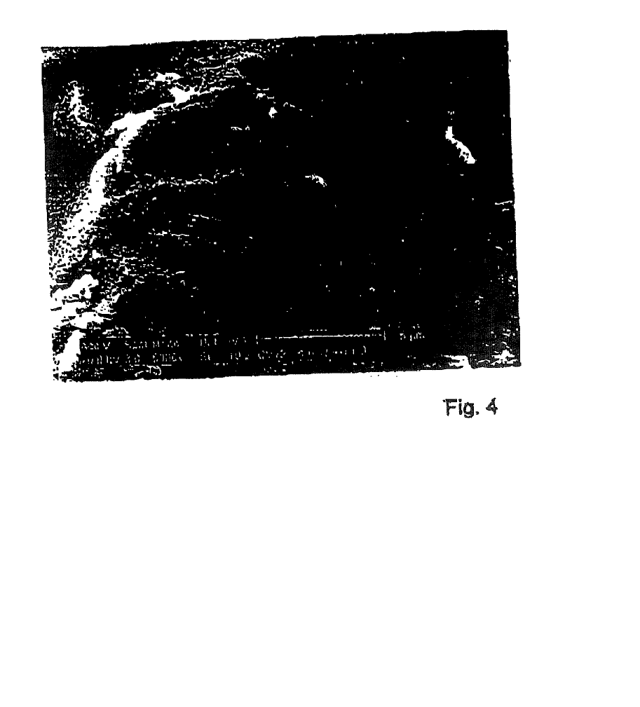

FIG. 4 shows a scanning electron microscope image of a catalyst layer comprising small clusters which consist of platinum and ruthenium.

A particularly favorable coverage of the substrate results with a Pt:Ru ratio in the electrolyte of approximately 1:10 and an offset voltage of −1.2 V, and a further particularly expedient coverage results with a Pt:Ru ratio of approximately 1:20 and an offset voltage of 1.4 V. This value simultaneously provides maximum coverage of the substrate.

The active surface area of the catalytic converter behaves in a very similar way to the coverage. The maximum active surface area results with a Pt:Ru ratio of 1:20 and an offset value of 1.4 V. A local maximum is observed at 1.2 V and a Pt:Ru ratio of 1:10. A saddle point is observed at 1.3 V and a Pt:Ru ratio of 1:13.

A catalytic converter which has been produced according to the invention is particularly resistant to erosion, and its production is successfully reproducible. Process control is simple, and the catalyst properties can be set reproducibly by simple modifications to the deposition process. The material yield is good, so that, for example for highly active catalytic converters, relatively small quantities of the catalytically active material have to be used.

The particular advantage when using a Pt/Ru mixed catalyst consists in the fact that the carbon monoxide conversion rate is improved and, at the same time, a platinum poisoning caused by the carbon monoxide (CO) is reduced.

Since the chemisorption of CO on a platinum surface is very high, a pure Pt catalytic converter tends to be poisoned under the influence of CO, i.e. all the active centres on the surface are blocked and CO can only be converted with difficulty. By contrast, ruthenium activates oxygen very strongly and, at the boundary layer of a Pt/Ru mixed catalytic converter, provides it to the activated CO on the platinum surface. Ruthenium also has the effect of activating water. A water molecule on a ruthenium surface is cleaved into an adsorbed OH group and adsorbed H. The activated OH group reacts with an activated CO molecule on the platinum surface to form CO₂. All that remains on the platinum surface is an absorbed H, which is immediately reacted with oxygen to form water.

It has been found that a Pt/Ru mixed catalytic converter activates not only oxygen but also hydrogen. The degree of hydrogen coverage of a Pt/Ru catalytic converter is generally higher than for a pure Pt catalytic converter, Therefore, a Pt/Ru catalytic converter of this type has very good cold-starting properties with a hydrogen/air mixture. With a gas composition containing 3 nl/min of H₂ and 27 nl/min of air, the gas ignites on the catalytic converter surface at approximately 50° C., with complete hydrogen conversion.

Good results are also achieved when used as a catalytic converter in a catalytic burner in a gas-cleaning system of a fuel cell system which is operated with a hydrogen-rich reformate, the intention being for the reformer exhaust gas to be cleaned in the catalytic burner. The CO conversion rate is high and improves the higher the temperature of the catalytic burner. Since, as the CO content rises, the high combustion enthalpy of CO generates more thermal energy during the CO combustion, the conversion of CO is already improved by 1-2 percentage points if the input quantity of carbon monoxide is increased slightly, for example by 0.05 nl/min. A relatively high water content in the gas mixture flow also has an advantageous effect.

A preferred use of a catalytic converter produced according to the invention involves the use in a CO-rich environment, in particular in an exhaust-gas cleaning installation in a motor vehicle. A further preferred use of a catalytic converter according to the invention involves its use in a fuel cell system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Process for producing a catalytic converter, in which catalytically active material is electrochemically deposited on. a substrate as a result of the substrate being immersed in an electrolyte, which contains the catalytically active material, and an electric voltage being applied between the substrate, and a counterelectrode, said process comprising one of:
(i) depositing platinum on a metallic substrate from a platinum-containing sulphuric acid solution; and
(ii) depositing a platinum/ruthenium mixture on a metallic substrate from a sulphuric acid solution containing platinum and ruthenium as catalytically active material, with a Pt:Ru ratio of 1:10 to 1:20.

2. Process according to claim 1, wherein the electrolyte is subjected to an ageing process prior to the deposition of the catalytically active material.

3. Process according to claim 2, wherein the electrolyte is aged by the action of electromagnetic radiation and/or air and/or oxygen.

4. Process according to claim 3, wherein the electrolyte is used after it has been aged for at least 20 hours.

5. Process according to claim 1, wherein the electrolyte remains substantially immobile during the deposition.

6. Process according to claim 1, wherein prior to the deposition, gases which are dissolved in the electrolyte are flushed out by inert gas.

7. Process according to claim 1, wherein a steel selected from a group of chromium steels consisting of 1.4541 and/or 1.4571 and/or 1.4767 is used as the substrate.

8. Process according to claim 1, wherein an electric direct voltage (V_{dc}) of between 1 and 1.4 volts is applied between the substrate and the counterelectrode.

9. The process as claimed in claim 1, wherein a modulated electric voltage is applied between the substrate and the counterelectrode, an alternating voltage (V_{ac}) being superimposed on a direct voltage (V_{dc}).

10. Process according to claim 1, wherein the alternating voltage (V_{ac}) has an amplitude which is lower than the direct voltage (V_{dc}).

11. Process according to claim 1, wherein, during a co-deposition, the direct voltage (V_{dc}) at least corresponds to the deposition potential of the catalytically active material which has the higher deposition potential.

12. Process according to claim 1, wherein the substrate is roughened on its surface which is to be coated prior to the deposition.

13. Process according to claim 1, wherein the counterelectrode is formed by platinum-coated titanium.

14. Process according to claim 1, wherein said process comprises said deposition of platinum on a metallic substrate from a platinum-containing sulphuric acid solution.

15. Process according to claim 1, wherein said process comprises said deposition of a platinum ruthenium mixture on a metallic substrate from a sulphuric acid solution containing platinum and ruthenium as catalytically active material, with a Pt:Ru ratio of 1:10 to 1:20.

16. Catalytic converter in a fuel cell system which is produced as set forth in claim 1.

17. Catalytic converter in a fuel cell system which is produced as set forth in claim 2.

18. Catalytic converter in a fuel cell system which is produced as set forth in claim 3.

19. Catalytic converter in a fuel cell system which is produced as set forth in claim 4.

20. Catalytic converter in a fuel cell system which is produced as set forth in claim 5.

21. Catalytic converter in a fuel cell system which is produced as set forth in claim 6.

22. Catalytic converter in a fuel cell system which is produced as set forth in claim 7.

23. Catalytic converter in a fuel cell system which is produced as set forth in claim 8.

24. Catalytic converter in a fuel cell system which is produced as set forth in claim 9.

25. Catalytic converter in a fuel cell system which is produced as set forth in claim 10.

26. Catalytic converter in a fuel cell system which is produced as set forth in claim 11.

27. Catalytic converter in a fuel cell system which is produced as set forth in claim 12.

28. Catalytic converter in an exhaust-gas cleaning system in a motor vehicle which is produced as set forth in claim 1.

29. Catalytic converter in an exhaust-gas cleaning system in a motor vehicle which is produced as set forth in claim 2.

30. Catalytic converter in an exhaust-gas cleaning system in a motor vehicle which is produced as set forth in claim 3.

31. Catalytic converter in an exhaust-gas cleaning system in a motor vehicle which is produced as set forth in claim 4.

32. Catalytic converter in an exhaust-gas cleaning system in a motor vehicle which is produced as set forth in claim 5.

33. Catalytic converter in an exhaust-gas cleaning system in a motor vehicle which is produced as set forth in claim 6.

34. Catalytic converter in an exhaust-gas cleaning system in a motor vehicle which is produced as set forth in claim 7.

35. Catalytic converter in an exhaust-gas cleaning system in a motor vehicle which is produced as set forth in claim 8.

36. Catalytic converter in an exhaust-gas cleaning system in a motor vehicle which is produced as set forth in claim 9.

37. Catalytic converter in an exhaust-gas cleaning system in a motor vehicle which is produced as set forth in claim 10.

38. Catalytic converter in an exhaust-gas cleaning system in a motor vehicle which is produced as set forth in claim 11.

39. Catalytic converter in an exhaust-gas cleaning system in a motor vehicle which is produced as set forth in claim 12.

40. A fuel cell system catalytic converter catalytically active material electrochemically deposited on a substrate by immension of the substrate in a electrolyte containing the catalytically active material with an electric voltage applied between the substrate and a counter electrode and with said deposited material being one of:
(i) platinum deposited from a platinum containing sulphuric acid solution, and
(ii) platinum and ruthenium from a sulphuric acid solution with a Pt:Ru ratio of from 1:10 to 1:20.

41. A fuel cell system catalytic converter according to claim 40, wherein said deposited material is platinum deposited from a platinum containing sulphuric acid solution.

42. A fuel exhaust gas cleaning system catalytic converter according to claim 40, wherein said deposited material is platinum and ruthenium from a sulphuric acid solution with a Pt:Ru ratio of from 1:10 to 1:20.

43. A fuel exhaust gas cleaning system catalytic converter according to claim 40, wherein said deposited material is platinum deposited from a platinum containing sulphuric acid solution.

44. A fuel exhaust gas cleaning system catalytic converter according to claim 40, wherein said deposited material is platinum and ruthenium from a sulphuric acid solution with a Pt:Ru ratio of from 1:10 to 1:20.
